(19) United States
(12) Patent Application Publication
(10) Pub. No.: US 2025/0065487 A1
(43) Pub. Date: Feb. 27, 2025

(54) ELECTRIC TOOL

(71) Applicant: MOBILETRON ELECTRONICS CO., LTD., Taichung City (TW)

(72) Inventors: CHENG-I TENG, Taichung City (TW); TUNG-CHIN KUO, Taichung City (TW)

(73) Assignee: MOBILETRON ELECTRONICS CO., LTD., Taichung City (TW)

(21) Appl. No.: 18/795,095

(22) Filed: Aug. 5, 2024

(30) Foreign Application Priority Data
Aug. 23, 2023 (TW) 112208981

(51) Int. Cl. B25F 5/02; B25B 23/147; B25F 5/00

(52) U.S. Cl. CPC B25F 5/02; B25F 5/001; B25B 23/1475

(57) ABSTRACT

An electric tool includes a body and a display device. The body has a main body portion and an operating portion. The body has a head portion and a rear portion that are located on a straight axis which is virtual. The operating portion has a connecting portion and a holding portion. Two ends of the connecting portion are respectively connected to the rear portion and the holding portion. The holding portion is located on the straight axis. A distance is provided between the holding portion and the rear portion. The rear portion has a mounting wall facing the holding portion. The display device is disposed on the rear portion and has a display portion exposed outside the mounting wall to show an operational status of the electric tool. Therefore, the holding portion could shield the display portion, reducing the likelihood of damage to the display portion due to collisions.

### BACKGROUND OF THE INVENTION

### Technical Field

The present invention relates generally to an electric tool, and more particularly to an electric tool with a display device that shows an operational status of the electric tool, wherein the display device is disposed at a particular position on a housing of the electric tool, so that the display device is less prone to damage from collisions and is easy for a user to view.

### Description of Related Art

In the description of the present invention, an electric tool is a portable tool powered by a motor, such as an electric wrench, an electric screwdriver, an electric drill, and an electric nail gun. With the increasing demand for precision in work, electric tools are required to have more precise power output control. For example, a torque output of the electric tool must be limited to a preset torque value, or even to a torque value selected or input by an operator. Therefore, in recent years, most electric tools on the market have a display device provided on a body of the electric tool. The display device not only shows a preset maximum torque output value but also shows other operational status information of the electric tool, such as battery level, motor speed, and temperature.

However, electric tools frequently collide with other objects during use. The display devices on most electric tools on the market are LCD screens, which are easily damaged during the collisions, causing the display devices to lose the display function of the display devices.

### BRIEF SUMMARY OF THE INVENTION

In view of the above, the primary objective of the present invention is to provide an electric tool including a display device, wherein the display device is disposed at a particular position on a housing of the electric tool, so that the display device is less prone to damage from collisions with other objects. Moreover, an angle at which the display device is disposed is also easy for a user to view, ensuring that changes in the position of the display device do not affect the user from viewing the display device.

The present invention provides the electric tool that includes a body, a motor, a reducing gear set, an output shaft, a control circuit, and a display device. The body has a main body portion and an operating portion. The main body portion has a head portion and a rear portion, both located on a straight axis which is virtual. The operating portion has a connecting portion and a holding portion. Two ends of the connecting portion are respectively connected to the rear portion and the holding portion. The holding portion is located on the straight axis. A distance is provided between the holding portion and the rear portion. Moreover, the rear portion has a mounting wall facing the holding portion. The rear portion, the connecting portion, and the holding portion integrally form an operation space. The holding portion has a base portion and an end portion. The base portion is connected to the connecting portion and the end portion is away from the base portion. The end portion is not connected to the rear portion. A channel is provided between the end portion and the rear portion. The motor, the reducing gear set, and the output shaft are arranged in the main body portion, from the rear portion to the head portion along the straight axis. The output shaft has a driving head protrudes out of the head portion. The reducing gear set is connected to both of the motor and the output shaft. The control circuit is disposed in the body and is adapted to control an operation of the motor. The display device is disposed on the rear portion and has a display portion exposed outside the mounting wall. The display device is electrically connected to the control circuit to receive a signal of an operational status of the electric tool from the control circuit. The display device shows the operational status on the display portion. Since the display device is disposed on the rear portion and the display portion is exposed outside the mounting wall, the holding portion located at the distance from the rear portion could shield the display portion, reducing the likelihood of the display portion being collided with external objects

In an embodiment, the holding portion has a holding axis which is virtual. The holding axis passes through the base portion and the end portion and is perpendicular to the straight axis. Therefore, the holding portion shields the display portion more completely.

In an embodiment, the display portion has a surface, wherein the surface has a first end edge and a second end edge. The second end edge is farther from the straight axis compared to the first end edge. A holding axis, which is virtual, passes through the base portion and the end portion. The second end edge is closer to the holding axis compared to the first end edge. Therefore, the content shown on the display portion is easier for the user to view during the operation of the electric tool.

In an embodiment, the display portion has a surface, wherein the surface and the connecting portion are respectively located on a top side and a bottom side of the straight axis. A virtual straight line is parallel to the surface and intersects the straight axis. An angle is provided between the virtual straight line and the straight axis, wherein the angle is less than 90 degrees. Preferably, the angle is between 65 degrees and 75 degrees. Therefore, the content shown on the display portion is easier for the user to view during the operation of the electric tool.

In an embodiment, the electric tool further includes a setting module disposed on the rear portion and electrically connected to the control circuit, wherein the setting module includes the display device and a setting interface exposed outside the mounting wall. The setting interface has a first button, a second button, and a third button. The first button, the second button, and the third button are shown on the display portion of the display device during a setting operation. The first button is used to select a setting mode, a default setting mode, a custom setting mode and to switch to a display mode. The setting mode includes any combination of one or more of: a torque value setting mode, a rotational speed value setting mode, a voltage value setting mode, a hammer strike number setting mode, a torque error value setting mode. The default setting mode includes at least one defined torque value. The custom setting mode comprises at least one custom torque value. The second button increases values in any of the setting mode and switches to a next page in the display mode. The third button decreases values in any of the setting mode and switches to a previous page in the display mode. When the electric tool is in the torque error value setting mode of the setting mode, simultaneously pressing both of the second button and the third button activates or deactivates an automatic torque adjustment mode.

In an embodiment, the rear portion, the setting interface, the connecting portion, and the holding portion integrally form the operation space for operating the electric tool. The setting interface is located near the channel. Therefore, a space is provided for operating the setting interface, enhancing the operational convenience of the electric tool.

In an embodiment, the electric tool includes at least one battery pack disposed on the main body portion, wherein the at least one battery pack is disposed on a left side or on a right side of the setting interface. Therefore, the at least one battery pack provides a shield for the display portion, thereby reducing the likelihood of lateral collision on the display portion. In other embodiments, the number of the battery pack is two, wherein the battery packs are respectively disposed on the left side and on the right side of the setting interface. Moreover, using either a single battery pack or two battery packs could make the electric tool operate normally. In terms of enhancing the protective effect of the shield for the display portion, using the two battery packs provides better protection for the display portion than using a single battery pack.

In an embodiment, the display device is a touch display panel, and the display portion is a touch display portion. The touch display panel shows the touch display portion and controls the control circuit upon being touched. The touch display portion has a first display area, a second display area, a first touch area, a second touch area, and a third touch area, but not limited thereto. The first display area is for showing a torque output value set for the electric tool. The second display area is for showing the information of the operational status. The first touch area is for switching the touch display panel to show various set parameters. The second touch area and the third touch area are for setting a torque value, an operation time, an impact parameter, and other set parameters for the electric tool, but not limited thereto.

It is noteworthy that in any embodiment of the present invention, the electric tool could be used to tighten or loosen a screw, a bolt, a nut, or any object with a fastening function. In order to illustrate easily, the bolt would be used as an example in the following description.

Additionally, it is noteworthy that in any embodiment of the invention, the display device could also be a touch display panel, and the display portion could be a touch display portion. The main difference is that the touch display panel and the touch display portion could be operated through touching. In order to illustrate easily, only the display device or the display portion is used as an example in the drawings and the specification. However, in practice, the display device could be the touch display panel, and the display portion could be the touch display portion. Touch operation should fall within the scope of the present invention.

### BRIEF DESCRIPTION OF THE SEVERAL VIEWS OF THE DRAWINGS

The present invention would be best understood by referring to the following detailed description of some illustrative embodiments in conjunction with the accompanying drawings, in which

FIG. 1 is a perspective view of the electric tool according to an embodiment of the present invention;

FIG. 2 is a partially exploded view of the electric tool according to the embodiment of the present invention;

FIG. 3 is a top view of the electric tool according to the embodiment of the present invention;

FIG. 4 is a sectional view along the 4-4 line in FIG. 3;

FIG. 5 is a side view of the electric tool according to the embodiment of the present invention;

FIG. 6 is a schematic view showing the display device of the touch display panel according to another embodiment of the present invention.

### DETAILED DESCRIPTION OF THE INVENTION

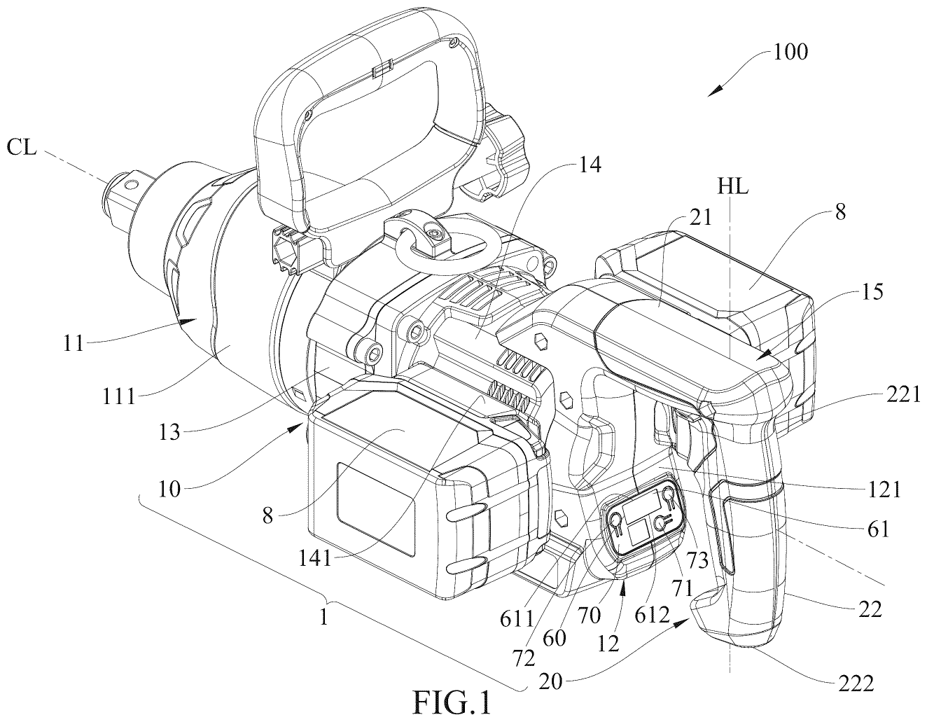

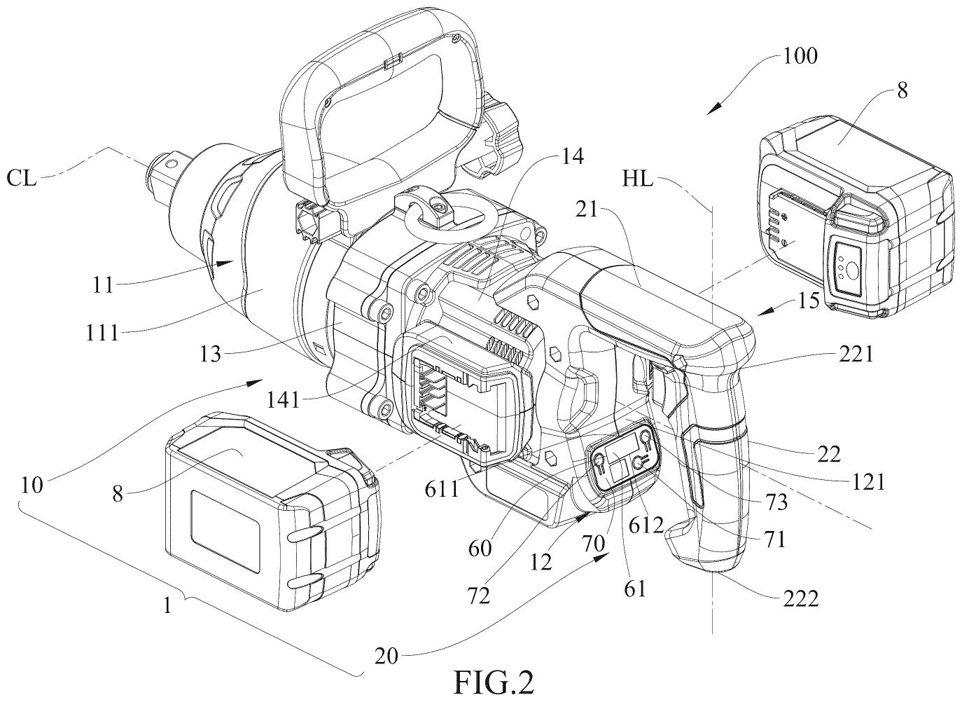

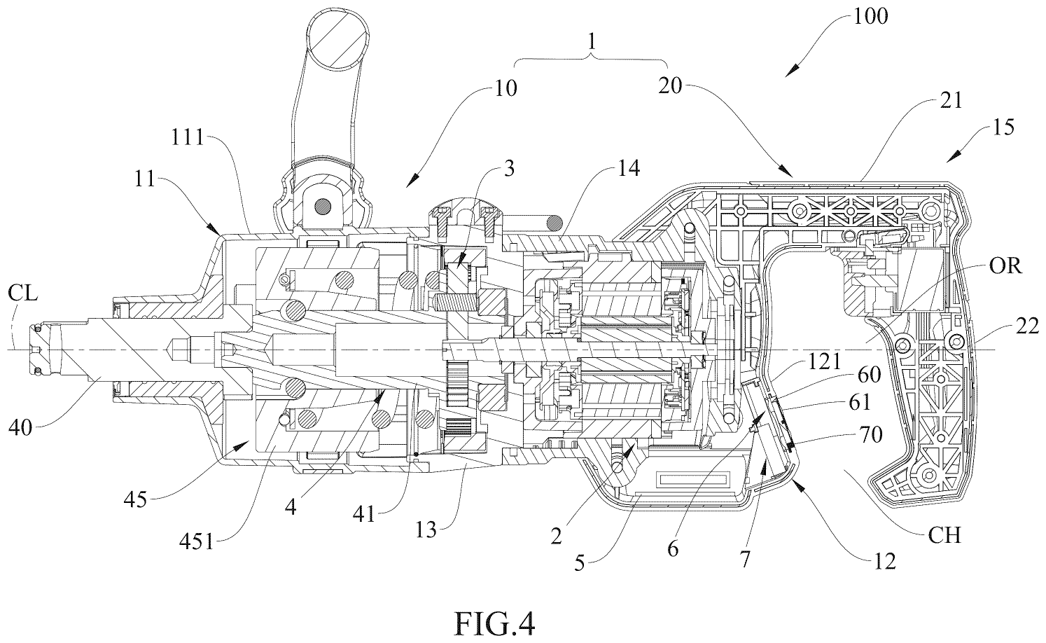

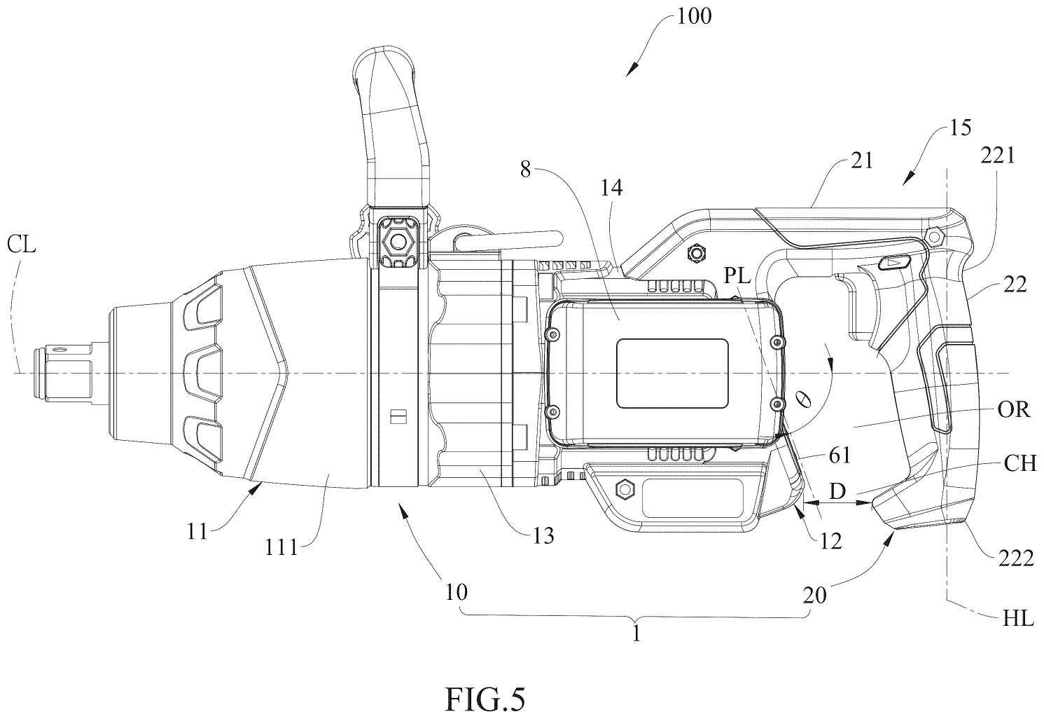

An electric tool 100 according to an embodiment of the present invention is illustrated in FIG. 1, FIG. 2, FIG. 4 and FIG. 5 and is an impact wrench adapted to tighten a bolt onto an object or to remove the bolt from the object. The electric tool 100 includes a body 1, a motor 2, a reducing gear set 3, an output shaft 4, an impact device 45, a control circuit 5, and a display device 6.

The body 1 has a main body portion 10 and an operating portion 20. The main body portion 10 has a head portion 11 and a rear portion 12, wherein both the head portion 11 and the rear portion 12 are located on a straight axis CL which is virtual. The operating portion 20 has a connecting portion 21 and a holding portion 22. Two ends of the connecting portion 21 are respectively connected to the rear portion 12 and the holding portion 22, so that the holding portion 22 is located on the straight axis CL and a distance D is provided between the holding portion 22 and the rear portion 12. Moreover, the rear portion 12 has a mounting wall 121 facing the holding portion 22.

The motor 2, the reducing gear set 3, and the output shaft 4 are arranged in the main body portion 10, from the rear portion 12 to the head portion 11 along the straight axis CL. The reducing gear set 3 is connected to both of the motor 2 and the output shaft 4. The reducing gear set 3 is adapted to decelerate a rotational output of the motor 2 and transmit the rotational output of the motor 2 to the output shaft 4. The impact device 45 is disposed in the head portion 11 and has an impact drill 451 fitted around the output shaft 4. In the current embodiment, when the electric tool 100 encounters a certain degree of resistance while tightening or loosening a bolt, the impact drill 451 of the impact device 45 applies an intermittent impact force to the output shaft 4 in a direction the same as a rotational direction of the output shaft 4. The intermittent impact force provides the output shaft 4 with an intermittent auxiliary torque to overcome the resistance.

In the current embodiment, the output shaft 4 includes a driving head 40 and a shaft body 41, wherein the driving head 40 is connected to the shaft body 41 along the straight axis CL. The driving head 40 protrudes out of the head portion 11 to connect with a bolt sleeve. Moreover, the impact drill 451 is fitted around the shaft body 41. In the current embodiment, when the electric tool 100 encounters the certain degree of resistance while tightening or loosening the bolt, the impact drill 451 applies the intermittent impact force to the output shaft 4.

The control circuit 5 is disposed in the body 1 and is adapted to control an operation of the motor 2.

The display device 6 is disposed on the rear portion 12 and has a display portion 60 exposed outside the mounting wall 121. The display device 6 is electrically connected to the control circuit 5 to receive a signal of an operational status of the electric tool 100 from the control circuit 5. The display device 6 shows the operational status on the display portion 60.

In the current embodiment, the display device 6 is a monochrome liquid crystal display panel (LCD), but the display device 6 is not limited thereto. The display device 6 could also be a color liquid crystal display panel (LCD), a monochrome or color electronic paper (E-Paper), a monochrome or color electronic ink (E-Ink), a color light-emitting diode display panel (LED), a color organic light-emitting diode display panel (OLED), a monochrome or color seven-segment display, a monochrome or color fourteen-segment display, a monochrome or color sixteen-segment display, or a monochrome or color dot matrix LED display. Any display device that presents information through light and shadow effects falls within the scope of the display device 6.

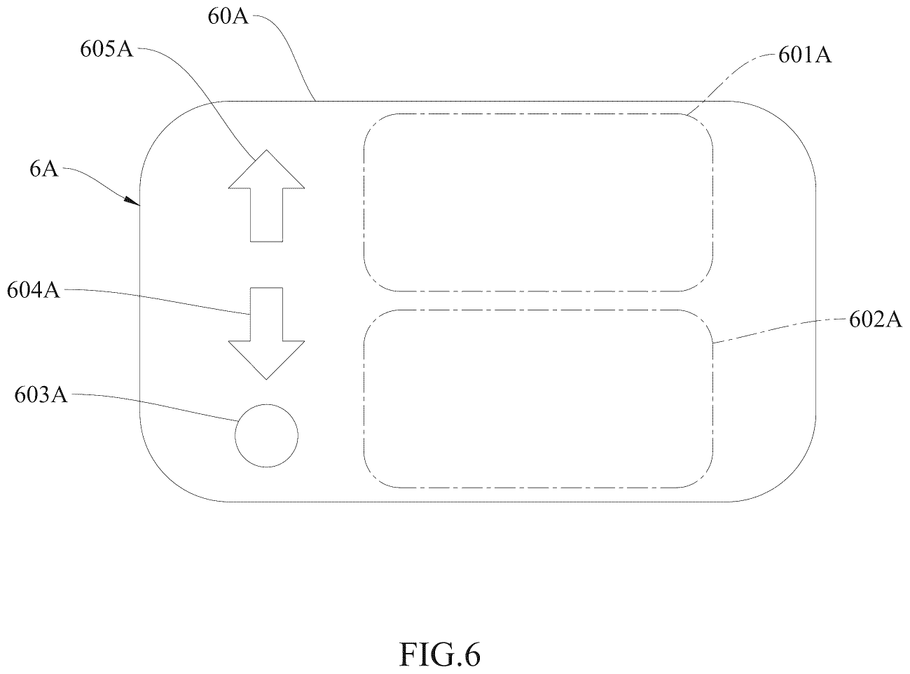

Referring to FIG. 6, in another embodiment, the display device 6 could also be a touch display panel 6A, and the display portion 60 could also be a touch display portion 60A. The touch display panel 6A has the function of showing the operational status on the touch display portion 60A and controlling the control circuit 5 when the touch display portion 60A is touched. The touch display portion 60A has a first display area 601A, a second display area 602A, a first touch area 603A, a second touch area 604A, and a third touch area 605A. The first display area 601A shows a torque output value set for the electric tool 100. The second display area 602A shows other information of the operational status of the electric tool 100, such as battery level, motor speed, and temperature. Moreover, the contents shown on the touch display panel 6A could be switched by touching the first touch area 603A. For example, the information shown on the first display area 601A could be switched to a torque value, an operation time, an impact parameter, or other set parameters. The torque value, the operation time, the impact parameter, or other set parameters shown on the first display area 601A could be set by touching the second touch area 604A or the third touch area 605A. Therefore, the torque value, the operating time, the impact parameter, and other set parameters for the electric tool 100 could be set. It is important to note that FIG. 6 is presented for illustrative purposes and does not limit the actual appearance of the present invention. Any electric tool 100 with the touch display panel 6A should fall within the scope of the present invention.

The display areas of the touch display portion 60A are not limited to the first display area 601A and the second display area 602A. The set torque value and the information of the operational status of the electric tool 100 could also be shown on a single display area. Moreover, the touch areas are designed to replace buttons. The touch function or the range of the touch areas disposed on the touch display portion 60A are not limited to the first touch area 603A, the second touch area 604A, and the third touch area 605A. The range of each of the touch areas could be adjusted as needed, and the function of each of the touch areas could be defined according to requirements. The number of the touch areas could also be increased or decreased to meet different requirements. A switch is provided on the touch display portion 60A and is adapted to activate or deactivate the touch function of the touch display panel 6A. When the touch function of the touch display panel 6A is not in use, the touch function of the touch display panel 6A could be deactivated by manipulating the switch, thereby preventing accidental touches. Another switch could be provided on the touch display portion 60A and is adapted to activate or deactivate a display function of the touch display portion 60A. When the display function is not in use, the display function could be deactivated by manipulating the another switch, thereby achieving energy savings.

The display device 6 is disposed on the rear portion 12 and the display portion 60 or the touch display portion 60A is exposed outside the mounting wall 121. Therefore, the holding portion 22 located at the distance D from the rear portion 12 could shield the display portion 60 or the touch display portion 60A, reducing the likelihood of damage to the display portion 60 or the touch display portion 60A due to falls or collisions with external objects.

In the current embodiment, the body 1 is assembled in the following order along the straight axis CL: a front housing 111, a reducing gear set housing 13, a motor housing 14, and a handle 15. A part of the front housing 111 away from the reducing gear set housing 13 constitutes the head portion 11. The handle 15 has the rear portion 12, the connecting portion 21, and the holding portion 22.

The motor 2 is located in the motor housing 14. The reducing gear set 3 is a planetary gear set and is disposed on the reducing gear set housing 13. The output shaft 4 and the impact device 45 are located in the front housing 111. A part of the driving head 40 protrudes out of the front housing 111.

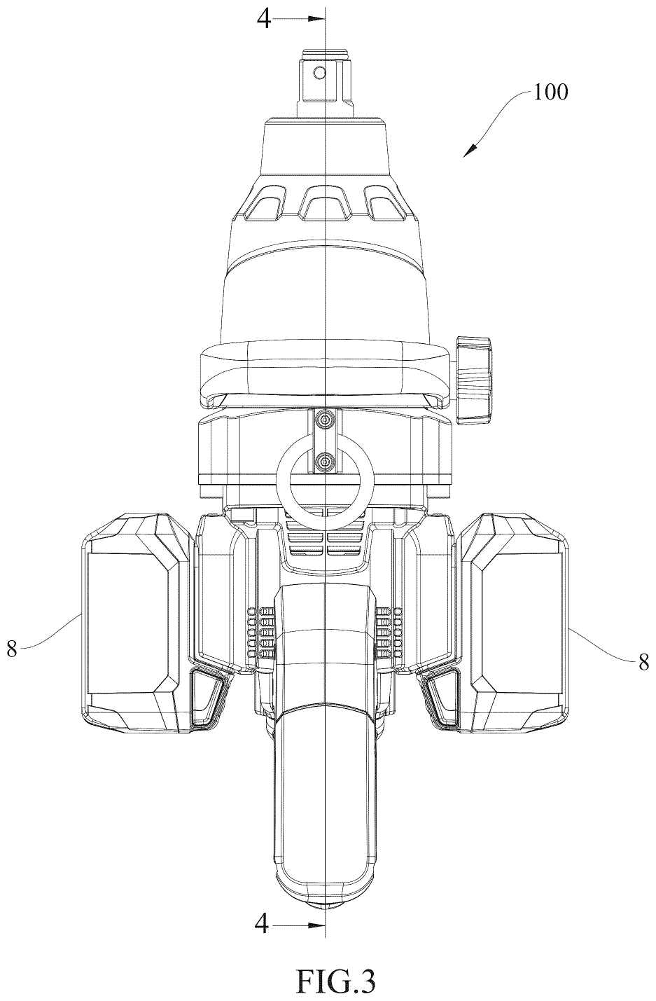

The motor housing 14 has at least one battery pack connection 141. In the current embodiment, the motor housing 14 has two battery pack connections 141. The battery pack connections 141 are respectively located on two symmetric positions of the motor housing 14. Each of the battery pack connections 141 is adapted to be connected to a battery pack 8 and to be electrically connected to the control circuit 5. Therefore, each of the battery packs 8 is a power source for the electric tool 100. Referring to FIG. 1 and FIG. 3, when each of the battery packs 8 is connected to each of the battery pack connections 141, a part of each of the battery packs 8 located near the rear portion 12 is located at a position that is close to one side (i.e., a left side or a right side) of the display portion 60 or the touch display portion 60A. Therefore, each of the battery packs 8 forms a protective shield for the display portion 60 or the touch display portion 60A, thereby reducing the likelihood of lateral collisions on the display portion 60 or the touch display portion 60A. As shown in FIG. 1 and FIG. 3, simultaneously using two battery packs 8 could reduce the likelihood of lateral collisions on two sides (i.e., both the left side and the right side) of the display portion 60, but not limited thereto. When a user wishes to reduce the weight of the electric tool 100, the user could only use a single battery pack 8, and the electric tool 100 would still function normally. Additionally, when using a single battery pack 8, the user could freely position the battery pack 8 on either the left side or the right side according to the dominant hand or operational habits of the user. As long as the battery pack 8 is installed properly and adequately charged, the power supply to the electric tool 100 would not be affected.

The holding portion 22 has a base portion 221 and an end portion 222, wherein the base portion 221 is connected to the connecting portion 21 and the end portion 222 is away from the base portion 221. As shown in FIG. 5, in the current embodiment, a holding axis HL, which is virtual and passes through the base portion 221 and the end portion 222, is perpendicular to the straight axis CL. Therefore, a wall surface of the holding portion 22 facing the rear portion 12 and a wall surface of the rear portion 12 facing the holding portion 22 are generally parallel, so that the holding portion 22 shields the display portion 60 from the outside more completely. Therefore, such design reduces the likelihood of the display portion 60 being collided with the external objects.

The display portion 60 has a surface 61, wherein the surface 61 has a first end edge 611 and a second end edge 612, which is farther from the straight axis CL compared to the first end edge 611. As shown in FIG. 5, in the current embodiment, the second end edge 612 is closer to the virtual holding axis HL compared to the first end edge 611. In other words, the surface 61 and the connecting portion 21 are respectively located on a bottom side and a top side of the straight axis CL. A virtual straight line PL is parallel to the surface 61 and intersects the straight axis CL. An angle θ is provided between the virtual straight line PL and the straight axis CL, wherein the angle θ is less than 90 degrees. Preferably, the angle θ is greater than 45 degrees and less than 90 degrees. More preferably, the angle θ is between 65 degrees and 75 degrees. Therefore, the display portion 60 generally faces the base portion 221 of the holding portion 22, so that the content shown on the display portion 60 is easier for the user to view during the operation of the electric tool 100.

As shown in FIG. 1, FIG. 2, and FIG. 4, in the current embodiment, the electric tool 100 further includes a setting module 7 disposed on the rear portion 12 and electrically connected to the control circuit 5. The setting module 7 includes the display device 6 and a setting interface 70 exposed outside the mounting wall 121. The setting interface 70 has the display portion 60. The setting interface 70 has a first button 71, a second button 72, and a third button 73. The first button 71, the second button 72, and the third button 73 are shown on the display portion 60 of the display device 6 during the setting operation. The first button 71 is used to select a setting mode, a default setting mode, a custom setting mode, and to switch to a display mode. The setting mode includes any combination of one or more of: a torque value setting mode, a rotational speed value setting mode, a voltage value setting mode, a hammer strike number setting mode, a torque error value setting mode. The default setting mode includes at least one defined torque value. The custom setting mode includes at least one custom torque value. The second button 72 increases values in the setting mode, the default setting mode, and the custom setting mode and switches to a next page in the display mode. The third button 73 decreases values in the setting mode, the default setting mode, and the custom setting mode and switches to a previous page in the display mode. When the electric tool 100 is in the torque error value setting mode of the setting mode, simultaneously pressing both of the second button 72 and the third button 73 would activate or deactivate an automatic torque adjustment mode.

In a first form of the setting mode, when the electric tool 100 is in the torque value setting mode of the setting mode and the user is about to increase the torque value of the electric tool 100 during operating the electric tool 100, the user could press the second button 72. Each short press of the second button 72 increases the torque value by 1 unit, and each long press of the second button 72 increases the torque value by 5 units or multiples of 5 units. The torque value could be increased to a maximum limit value X. When the user is about to decrease the torque value of the electric tool 100 in the torque value setting mode of the setting mode, the user could press the third button 73. Each short press of the third button 73 decreases the torque value by 1 unit, and each long press of the third button 73 decreases the torque value by 5 units or multiples of 5 units. The torque value could be decreased to a minimum limit value Y. The maximum limit value X and the minimum limit value Y of the torque value are arbitrary. In practice, the increase of the torque value by pressing the second button 72 or the decrease of the torque value by pressing the third button 73 could be adjusted according to actual needs to change the value of the increase or the value of the decrease of the torque value in the torque value setting mode of the setting mode. Moreover, the value of the increase and the value of the decrease of the torque value could be the same. For example, both of the value of the increase and the value of the decrease are 10 units. The value of the increase and the value of the decrease of the torque value could also be different. For example, pressing the second button 72 for every 0.02 seconds increases the torque value by 10 units, and pressing the third button 73 for every 0.02 seconds decreases the torque value by 5 units. The duration of each long press could also be adjusted based on design requirements.

In a second form of the setting mode, when the electric tool 100 is in the rotational speed value setting mode of the setting mode and the user is about to increase a rotational speed value of the electric tool 100 during operating the electric tool 100, the user could press the second button 72. Each short press of the second button 72 increases the rotational speed value by 10 unit, and each long press of the second button 72 increases the rotational speed value by multiples of 10 units or multiples of 20 units. The rotational speed value could be increased to a maximum limit value X. When the user is about to decrease the rotational speed value of the electric tool 100, the user could press the third button 73. Each short press of the third button 73 decreases the rotational speed value by 10 unit, and each long press of the third button 73 decreases the rotational speed value by multiples of 10 units or multiples of 20 units. The rotational speed value could be decreased to a minimum limit value Y. The maximum limit value X and the minimum limit value Y of the rotational speed value are arbitrary. In practice, the increase of the rotational speed value by pressing the second button 72 or the decrease of the rotational speed value by pressing the third button 73 could be adjusted according to actual needs to change the increase or the decrease of the rotational speed value in the rotational speed value setting mode of the setting mode. Moreover, the value of the increase and the value of the decrease of the rotational speed value could be the same. For example, both of the value of the increase and the value of the decrease are 10 units. However, the value of the increase and the value of the decrease of the rotational speed value could also be different. For example, pressing the second button 72 for every 0.02 seconds increases the rotational speed value by 20 units, and pressing the third button 73 for every 0.02 seconds decreases the rotational speed value by 10 units. The duration of each long press could also be adjusted based on requirements.

In a third form of the setting mode, when the electric tool 100 is in the voltage value setting mode of the setting mode and the user is about to increase a voltage value of the electric tool 100 during operating the electric tool 100, the user could press the second button 72. Each short press of the second button 72 increases the voltage value by 0.01 unit, and each long press of the second button 72 increases the voltage value by multiples of 5 units or multiples of 10 units. The voltage value could be increased to a maximum limit value X. When the user is about to decrease the voltage value of the electric tool 100, the user could press the third button 73. Each short press of the third button 73 decreases the voltage value by 0.01 unit, and each long press of the third button 73 decreases the voltage value by multiples of 5 units or multiples of 10 units. The voltage value could be decreased to a minimum limit value Y. The maximum limit value X and the minimum limit value Y of the voltage value are arbitrary. In practice, the increase of the voltage value by pressing the second button 72 or the decrease of the voltage value by pressing the third button 73 could be adjusted according to actual needs to change the increase or the decrease of the voltage value in the voltage value setting mode of the setting mode. Moreover, the value of the increase and the value of the decrease of the voltage value could be the same. For example, both of the value of the increase and the value of the decrease are 0.01 units. However, the value of the increase and the value of the decrease of the voltage value could also be different. For example, pressing the second button 72 for every 0.02 seconds increases the voltage value by 0.01 units, and pressing the third button 73 for every 0.02 seconds decreases the voltage value by 0.05 units. The duration of each long press could also be adjusted based on requirements.

In a fourth form of the setting mode, when the electric tool 100 is in the hammer strike number setting mode of the setting mode and the user is about to increase a hammer strike number of the electric tool 100 during operating the electric tool 100, the user could press the second button 72. Each short press of the second button 72 increases the hammer strike number by 1, and each long press of the second button 72 increases the hammer strike number by multiples of 5 or multiples of 10. The hammer strike number could be increased to a maximum limit value X. The maximum limit value X of the hammer strike number is arbitrary. When the user is about to decrease the hammer strike number of the electric tool 100, the user could press the third button 73. Each short press of the third button 73 decreases the hammer strike number by 1, and each long press of the third button 73 decreases the hammer strike number by multiples of 5 or multiples of 10. The hammer strike number could be decreased to a minimum limit value which is 1. In practice, the increase of the hammer strike number by pressing the second button 72 or the decrease of the hammer strike number by pressing the third button 73 could be adjusted according to actual needs to change the value of the increase or the value of the decrease of the hammer strike number in the hammer strike number setting mode of the setting mode. Moreover, the value of the increase and the value of the decrease of the hammer strike number could be the same. For example, both of the value of the increase and the value of the decrease of the hammer strike number are 1. However, the value of the increase and the value of the decrease of the hammer strike number could also be different. For example, pressing the second button 72 for every 0.02 seconds increases the hammer strike number by 5, and pressing the third button 73 for every 0.02 seconds decreases the hammer strike number by 10. The duration of each long press could also be adjusted based on design requirements.

In a fifth form of the setting mode, when the electric tool 100 is in the torque error value setting mode of the setting mode and the user is about to increase a torque error value of the electric tool 100 during operating the electric tool 100, the user could press the second button 72. Each short press of the second button 72 increases the torque error value by 1%, and each long press of the second button 72 increases the torque error value by 5%. The torque error value could be increased to a maximum limit value which is 20%. When the user is about to decrease the torque error value of the electric tool 100, the user could press the third button 73. Each short press of the third button 73 decreases the torque error value by 1%, and each long press of the third button 73 decreases the torque error value by 5%. The torque error value could be decreased to a minimum limit value which is-20%. In practice, the increase of the torque error value by pressing the second button 72 or the decrease of the torque error value by pressing the third button 73 could be adjusted according to actual needs to change the value of the increase or the value of the decrease of the torque error value in the torque error value setting mode of the setting mode. Moreover, the value of the increase and the value of the decrease of the torque error value could be the same. For example, both of the value of the increase and the value of the decrease are 1%. The increment percentage and the decrement percentage of the torque error value could also be different. For example, pressing the second button 72 for every 0.02 seconds increases the torque error value by 10%, and pressing the third button 73 for every 0.02 seconds decreases the torque error value by 5%. The duration of each long press could also be adjusted based on requirements.

In a sixth form of the setting mode, when the electric tool 100 is in the torque value setting mode of the setting mode and the user is about to make the electric tool 100 self-adapt, thereby making the electric tool 100 automatically adjust the torque value of the electric tool 100, the user could simultaneously press the second button 72 and the third button 73 for 1 second to activate or deactivate the automatic torque adjustment mode. The automatic adjustment mode is to automatically increase and adjust an original torque value or an original rotational speed value of the electric tool 100 when the original torque value or the original rotational speed value of the electric tool 100 is insufficient to make an output torque value of the electric tool 100 sufficient for tightening or loosening, so that the output torque value of the electric tool 100 could be sufficient for tightening or loosening. Therefore, the user does not need to adjust the torque value or the rotational speed value of the electric tool 100 additionally and the automatic adjustment mode ensures that the output torque value is sufficient for tightening or loosening without damaging a fastening medium, thus preventing thread stripping or breakage.

The default setting mode includes the at least one defined torque value. The default setting mode refers to the at least one defined torque value pre-written into the electric tool 100 before the electric tool 100 leaves the factory (i.e., before the electric tool 100 is acquired by the user). The at least one defined torque value is determined based on a plurality of parameters and the requirements of orders or designs, wherein the parameters include the torque value, the rotational speed value, the voltage value, and the hammer strike number. When the user starts operating the electric tool 100, the user could choose the at least one defined torque value of the default setting mode which the parameters corresponding to the at least one defined torque value has been previously set by the factory. For example, to avoid an operator incorrectly setting parameters, when the electric tool 100 is on the assembly line in the factory, the at least one defined torque value in the default setting mode could be chosen. The torque value, the rotational speed value, the voltage value, and the hammer strike number, which are in correspondence to the at least one defined torque value, are set before leaving the factory. The parameters, which are previously set, would be automatically imported into the electric tool 100, thereby reducing the likelihood of setting errors during the parameter setting process. It is noteworthy that the number of the defined torque value could be one or more than one. Moreover, the design of the parameters could be designed according to a standard specification or specific requirements.

The custom setting mode includes the at least one custom torque value. The custom setting mode refers to that the user could input the at least one custom torque value into the electric tool 100 after the electric tool 100 has left the factory (i.e., after the electric tool 100 has been acquired by the user). The at least one custom torque value is determined based on a plurality of parameters and the requirements of the user, wherein the parameters include the torque value, the rotational speed value, the voltage value, and the hammer strike number. When the user starts operating the electric tool 100, the user could choose the at least one custom torque value of the custom setting mode which the parameters corresponding to the at least one custom torque value has been previously set by the user. For example, to save time in setting the parameters, when using the electric tool 100, if there are significant variations between the parameters, the user could choose the at least one custom torque value in the custom setting mode. The torque value, the rotational speed value, the voltage value, and the hammer strike number, which are in correspondence to the at least one custom torque value, have been previously set by the user. The parameters, which are previously set, would be automatically imported into the electric tool 100, thereby saving time in setting the parameters and reducing the likelihood of setting errors. It is noteworthy that the number of the custom torque value could be one or more than one.

In the display mode, when the user wishes to know an operating status of the electric tool 100, the user could see a plurality of relevant setting values of the electric tool 100 on the display portion 60 of the display device 6 of the electric tool 100. Specifically, the display portion 60 shows the operating status of the electric tool 100. An information of the operating status includes a current torque value of the electric tool 100, a current rotational speed value of the electric tool 100, a current voltage value of the electric tool 100, a current hammer strike number of the electric tool 100, a torque error value of the electric tool 100, a status of any battery pack 8 disposed on the electric tool 100 (such as a remaining charge of the battery pack 8 or the two battery packs 8, an estimated remaining usage time based on the remaining charge, or an estimated time required for full charge), the date and the time, a current operating temperature of the electric tool 100, a current temperature of an operating environment of the electric tool 100, a current humidity of the operating environment of the electric tool 100, a previous torque value used in a last operation of the electric tool 100, a previous rotational speed value used in the last operation of the electric tool 100, a previous hammer strike number used in the last operation of the electric tool 100, a previous voltage value of the electric tool 100, and an operating history of the electric tool 100, but not limited thereto. The information of the operating status could include any one of the examples listed above, or any combination of the examples listed above. Moreover, the display portion 60 could show the information in a single page or multiple pages. In the display mode, when the display portion 60 shows the information in multiple pages, the second button 72 is for switching to the next page, and the third button 73 is for switching to the previous page. Moreover, it is noteworthy that the operating status of the electric tool 100 could also be shown or recorded on any external display device using wireless or wired transmission. For example, the operating status could be shown on a screen of a mobile device (such as a smartphone) and recorded in a memory device of the mobile device, but not limited thereto. Various forms of changes are within the scope of the present invention.

It is noteworthy that the second button 72 and the third button 73 are respectively located at two sides of the display portion 60, and the first button 71 is disposed below a horizontal line formed by the second button 72 and the third button 73, but not limited thereto. The position of the first button 71, the position of the second button 72, and the position of the third button 73 could be adjusted as needed. Moreover, if the display device 6 is the touch display panel 6A, the first button 71, the second button 72, and the third button 73 could be integrated into the touch function of the touch display panel 6A. In other words, if the display device 6 is the touch display panel 6A, the first button 71, the second button 72, and the third button 73 could be omitted. In other embodiments, the first button 71, the second button 72, and the third button 73 could exist selectively for operational convenience. In other words, in addition to the touch display panel 6A, at least one of the first button 71, the second button 72, or the third button 73 could exist. The position of the first button 71, the position of the second button 72, and the position of the third button 73 could be adjusted as needed.

Moreover, the first button 71, second button 72, and third button 73 described in the first form, the second form, the third form, the fourth form, the fifth form, and the sixth form of the setting mode could also be integrated into the touch display panel 6A. The setting mode, the default setting mode, the custom setting mode, and the display mode could also be integrated into the touch display panel 6A. The touch display portion 60A of the touch display panel 6A has the function of showing the setting mode, the default setting mode, the custom setting mode, and the display mode, as well as the function of controlling the control circuit 5 when the touch area on the touch display portion 60A is touched.

Additionally, in the default setting mode, since no parameter setting is required, only the first button 71 could be retained, and the second button 72 and the third button 73 could be omitted as needed. The first button 71 could also be integrated into the touch display panel 6A.

As shown in FIG. 5, the rear portion 12, the setting interface 70, the connecting portion 21, and the holding portion 22 integrally form an operation space OR for operating the electric tool 100, so that a space is provided for operating the setting interface 70.

The end portion 222 of the holding portion 22 is not connected to the rear portion 12, and a channel CH is provided between the end portion 222 of the holding portion 22 and the rear portion 12. The channel CH communicates with the operation space OR, and the setting interface 70 is located near the channel CH. In this way, the hand of the user could reach the setting interface 70 through the channel CH, so that the operation space OR could be enlarged for the hand of the user, thereby enhancing the convenience in operating the electric tool 100. It is noteworthy that the channel CH indicates that the rear portion 12 is not connected to the end portion 222 of the holding portion 22. The size, the style, and the configuration of the channel CH are not limited to the schematic views disclosed in the present invention. Any structure where the rear portion 12 is not connected to the end portion 222 of the holding portion 22 should fall within the scope of the present invention.

It must be pointed out that the embodiments described above are only some preferred embodiments of the present invention. All equivalent structures which employ the concepts disclosed in this specification and the appended claims should fall within the scope of the present invention.

What is claimed is:

1. An electric tool, comprising a body, a motor, a reducing gear set, an output shaft, a control circuit, and a display device;
wherein the body has a main body portion and an operating portion; the main body portion has a head portion and a rear portion; the head portion and the rear portion are located on a straight axis which is virtual; the operating portion has a connecting portion and a holding portion; two ends of the connecting portion are respectively connected to the rear portion and the holding portion; the holding portion is located on the straight axis; a distance is provided between the holding portion and the rear portion; the rear portion has a mounting wall facing the holding portion; the rear portion, the connecting portion, and the holding portion integrally form an operation space; the holding portion has a base portion and an end portion; the base portion is connected to the connecting portion and the end portion is away from the base portion; the end portion is not connected to the rear portion; a channel is provided between the end portion and the rear portion;
wherein the motor, the reducing gear set, and the output shaft are arranged in the main body portion, from the rear portion to the head portion along the straight axis; the output shaft has a driving head protrudes out of the head portion; the reducing gear set is connected to both of the motor and the output shaft;
wherein the control circuit is disposed in the body and is adapted to control an operation of the motor;
wherein the display device is disposed on the rear portion and has a display portion exposed outside the mounting wall; the display device is electrically connected to the control circuit to receive a signal of an operational status of the electric tool from the control circuit; the display device shows the operational status on the display portion.

2. The electric tool as claimed in claim 1, wherein the holding portion has a holding axis which is virtual; the holding axis passes through the base portion and the end portion and is perpendicular to the straight axis.

3. The electric tool as claimed in claim 1, wherein the display portion has a surface; the surface has a first end edge and a second end edge; the second end edge is farther from the straight axis compared to the first end edge; a holding axis, which is virtual, passes through the base portion and the end portion; the second end edge is closer to the holding axis compared to the first end edge.

4. The electric tool as claimed in claim 1, wherein the display portion has a surface; the surface and the connecting portion are respectively located on a top side and a bottom side of the straight axis; a virtual straight line is parallel to the surface and intersects the straight axis; an angle is provided between the virtual straight line and the straight axis, wherein the angle is less than 90 degrees.

5. The electric tool as claimed in claim 4, wherein the angle is between 65 degrees and 75 degrees.

6. The electric tool as claimed in claim 1, further comprising a setting module disposed on the rear portion and electrically connected to the control circuit, wherein the setting module comprises the display device and a setting interface exposed outside the mounting wall; the setting interface has a first button, a second button, and a third button; the first button, the second button, and the third button are shown on the display portion of the display device during a setting operation; the first button is used to select a setting mode, a default setting mode, a custom setting mode and to switch to a display mode; the setting mode comprises any combination of one or more of: a torque value setting mode, a rotational speed value setting mode, a voltage value setting mode, a hammer strike number setting mode, a torque error value setting mode; the default setting mode comprises at least one defined torque value; the custom setting mode comprises at least one custom torque value; the second button increases values in the setting mode, the default setting mode, and the custom setting mode and switches to a next page in the display mode; the third button decreases values in the setting mode, the default setting mode, and the custom setting mode and switches to a previous page in the display mode; when the electric tool is in the torque error value setting mode of the setting mode, simultaneously pressing both of the second button and the third button activates or deactivates an automatic torque adjustment mode.

7. The electric tool as claimed in claim 6, wherein the rear portion, the setting interface, the connecting portion, and the holding portion integrally form the operation space of the electric tool; the setting interface is located near the channel.

8. The electric tool as claimed in claim 6, further comprising at least one battery pack disposed on the main body portion, wherein the at least one battery pack is disposed on a left side or on a right side of the setting interface.

9. The electric tool as claimed in claim 6, wherein the display device is a touch display panel, and the display portion is a touch display portion; the touch display panel shows the touch display portion and controls the control circuit upon being touched.

10. The electric tool as claimed in claim 1, wherein the display device is a touch display panel, and the display portion is a touch display portion; the touch display panel shows the operational status on the touch display portion and controls the control circuit upon being touched.
